(19) United States
(12) Patent Application Publication
(10) Pub. No.: US 2024/0036557 A1
(43) Pub. Date: Feb. 1, 2024

(54) HONEYPOT FOR A CONNECTION BETWEEN AN EDGE DEVICE AND A CLOUD-BASED SERVICE PLATFORM

(71) Applicant: Endress+Hauser SE+Co. KG, Maulburg (DE)

(72) Inventors: Eric Birgel, Schopfheim (DE); Damian Schlager, Bad Bellingen (DE); Claudia Nowak, Freiburg (DE); Michael Kuhl, Haldenwang (DE); Johannes Sprenger, Lörrach (DE); Mirko Brcic, Rheinfelden (CH)

(21) Appl. No.: 18/258,763

(22) PCT Filed: Nov. 29, 2021
(86) PCT No.: PCT/EP2021/083405

§ 371 Date: Sep. 18, 2023

(30) Foreign Application Priority Data
Dec. 21, 2020 (DE) 10 2020 134 439.2

(51) Int. Cl. G05B 19/418

(52) U.S. Cl. CPC G05B 19/4185; G05B 19/4183; G05B 2219/36542

(57) ABSTRACT

A first plant part includes a multitude of field devices and an edge device, which is part of a communication network. The edge device monitors data transmitted by the field devices and a higher-level unit or requests further data. The edge device generates a live list, which contains an identifier of each field device or the higher-level unit and the requested or monitored data. The edge device simulates a multitude of virtual field devices, generates data, and enters identifiers of the virtual field devices and the generated data into the live list. The live list is made available via a first interface. The edge device transmits the live list containing the current requested or monitored data to a cloud-based service platform at regular intervals, and the cloud-based service platform is designed to prepare or present the live list, with the data of the virtual field devices being disregarded.

The invention relates to an automation system.

Field devices that are used in industrial installations are already known from the prior art. Field devices are often used in process automation engineering, as well as in manufacturing automation engineering. Field devices, in principle, refer to all devices that are process-oriented and that supply or process process-relevant data or information. Field devices are thus used for detecting and/or influencing process variables. Measuring devices, or sensors, are used for detecting process variables. These are used, for example, for pressure and temperature measurement, conductivity measurement, flow measurement, pH measurement, fill level measurement etc., and detect the corresponding process variables of pressure, temperature, conductivity, pH value, fill level, flow etc. Actuators are used for influencing process variables. These are, for example, pumps or valves that can influence the flow of a fluid in a pipe or the fill level in a tank. In addition to the aforementioned measuring devices and actuators, field devices are also understood to include remote I/Os, radio adapters, or, generally, devices that are arranged at the field level.

A multitude of such field devices is produced and marketed by the Endress+Hauser group.

In modern industrial plants, field devices are usually connected to superordinate units via communication networks such as fieldbuses (Profibus®, Foundation® Fieldbus, HART®, etc.). Usually, the higher-level units are control units, such as an SPC (stored program control) or a PLC (programmable logic controller). The higher-level units are used for, among other things, process control, as well as for commissioning of the field devices. The measured values detected by the field devices, especially by sensors, are transmitted via the respective bus system to a (or possibly several) higher-level unit(s) that further process the measured values, as appropriate, and forward them to the control station of the plant. The control station serves for process visualization, process monitoring and process control via the higher-level units. In addition, data transmission from the superordinate unit via the bus system to the field devices is also required, especially for configuration and parameterization of field devices and for controlling actuators.

In addition to the process values, field devices in the automation industry also provide analysis and status data, which are of crucial importance for the maintenance and care of the assets as well as for evaluating the condition of the system parts in which they are installed.

For the best and most comprehensive analysis of the data obtained from the field devices, it is necessary to collect them centrally and make them available in a differentiated manner to the groups of people and evaluation systems that can contribute their expertise to the evaluation of the conditions of system parts and their assets. There are now service providers for the data storage, data security and data processing functions required for this, such as the company “Endress+Hauser” with its “Netilion” platform.

In order to be able to transport these data from field devices to the cloud (a cloud-capable service platform which can be contacted by means of the Internet) within the framework of the above-mentioned digital services, edge devices are used which monitor or retrieve data from the field devices and upload them to the cloud by means of the Internet.

The data are sometimes sensitive information that must not get into the hands of third parties. For this purpose, the data are transmitted between edge device and cloud via a secure connection (e.g., encrypted symmetrically or asymmetrically). If such an encryption is broken or if a third party obtains the access data for the edge device or the cloud, plant knowledge can get into the hands of unauthorized persons since the communication between edge device and cloud could be read.

The object of the present invention is therefore to increase the security of the transmission of data between an edge device and a cloud-based service platform.

The object is achieved by an automation system comprising:
a first plant part consisting of a multitude of field devices and a higher-level unit, the field devices being designed to sense measured values of at least one physical variable of a process-engineering process and/or to influence at least one physical variable of a process-engineering process,
   wherein the field devices are in communication with one another and with the higher-level unit via a communication network, wherein the field devices are designed to transmit data, especially, the measured values, status values and/or diagnostic data, to the higher-level unit, and wherein the higher-level unit is designed to transmit data, especially, control values and/or operating telegrams, to the field devices;
an edge device, which is part of the communication network, wherein the edge device is designed to monitor at least some of the data transmitted by the field devices and by the higher-level unit and/or to request further data from the field devices and/or from the higher-level unit, wherein the edge device is designed to generate a live list, which contains an identifier of each of the field devices or of the control unit and the currently requested or monitored data, wherein the edge device is designed to simulate a multitude of virtual field devices, to generate data for the virtual field devices, to enter the identifiers of the virtual field devices and the generated data into the live list, and to make the live list available via a first interface, especially, an interface for application programming;
a cloud-based service platform, wherein the edge device is in communication with the service platform by means of the Internet via a first communication channel, wherein the edge device is designed to transmit the live list containing the current requested or monitored data to the service platform at regular intervals, and wherein the cloud-based service platform is designed to prepare and/or present the live list, wherein the data of the virtual field devices are disregarded.

The system according to the invention makes it possible to securely transmit data from field devices between an edge device and a cloud-based service platform. The essential aspect of the invention is that the edge device simulates further field devices which are not even located in the first plant part. The edge device writes these so-called virtual field devices into the live list, which is transmitted to the cloud-based service platform. The live list represents the entirety of all functional field devices in the first plant part. In addition, for each of the virtual field devices, the edge device simulates data that are transmitted to the cloud-based service platform. If an attacker succeeds in interrupting the connection between edge device and cloud-based service platform or in gaining access to the edge device via the first interface, they get a multitude of field devices and the data thereof displayed, of which only a fraction are actually field devices used in the first plant part. In this case, the attacker cannot distinguish which data actually originate from real field devices. As a result, the attacker is confused and time is gained to avert the attack, or the attacker quits the attack as a result since they cannot make use of the data.

However, only the field devices and their data that are actually contained in the first plant part are presented to the actual user of the cloud-based service platform.

Field devices that are cited in connection with the system according to the invention are already listed as examples in the introductory part of the description.

According to an advantageous embodiment of the system according to the invention, it is provided that the edge device is designed to encrypt the identifiers of the field devices and of the virtual field devices in the live list by means of a public key located on the edge device, wherein the service platform is designed to decrypt the encrypted identifiers with a public key located on the service platform, and wherein the identifiers of the virtual field devices cannot be decrypted. In this way, it is apparent to the cloud-based service platform which of the field devices are actually contained in the first plant part and which field devices are simulated by the edge device.

According to an advantageous embodiment of the system according to the invention, it is provided that the service platform is designed to simulate at least one second plant part with a multitude of further virtual field devices, to generate data for the further virtual field devices, to enter the identifiers of the further virtual field devices and the generated data into the live list and to make available the live list via a second interface, especially, an interface for application programming. This ensures further confusion of the attacker. If the attacker succeeds in gaining access to the cloud-based service platform via the second interface, they are overwhelmed by an additional multitude of further field devices and data. It is not even apparent to the attacker of which plant parts the plant actually consists. However, even in this case, only the field devices and their data that are actually contained in the first plant part, but none of the virtual or further virtual field devices, are presented to the actual user of the cloud-based service platform.

According to an advantageous embodiment of the system according to the invention, it is provided that the edge device or the service platform comprises an algorithm, especially, an AI algorithm, which is designed to analyze historical data of the field devices and to generate the data of the virtual field devices based on the analysis. As a result, the data of the virtual field devices are simulated similarly to the field devices actually used, e.g., in similar value ranges or similar trends. As a result, the security level is increased since the data of the virtual field devices are thus very plausible and practically no longer distinguishable from the field devices actually used.

According to an advantageous alternative embodiment of the system according to the invention, it is provided that the edge device or the service platform comprises an algorithm, especially, an AI algorithm, and at least one model of a field device type, wherein the model has at least one specific attribute of the corresponding field device type, and wherein the algorithm is designed to generate the data of the virtual field devices by using the model. The AI algorithm is trained in advance on various field device types and their specific attributes by means of training data. In doing so, the configuration and the parameterization of field devices actually used in the first plant part and having the same or a similar field device type can advantageously be included in order to increase the plausibility level. Specific attributes are, for example, value ranges, units of the measured values, specific decay or start-up behavior, etc.

According to an advantageous development of the system according to the invention, it is provided that the edge device has a first monitoring entity, which is designed to detect external access or an external request via the first interface to at least one of the virtual field devices and to create a first report. This makes it possible to determine that an unauthorized person has accessed the edge device: the actual user of the cloud-based service platform does not obtain access to the virtual field devices since they are not presented to him, and can therefore also not make any requests to these virtual field devices.

According to an advantageous embodiment of the system according to the invention, it is provided that the service platform has a second monitoring entity, which is designed to detect external access or an external request via the second interface to at least one of the further virtual field devices and to create a second report. Analogously to what is described in the previous paragraph, unauthorized access to the cloud-based service platform can thereby be detected.

According to an advantageous embodiment of the system according to the invention, it is provided that the first report and/or the second report contain information about the identifier of the virtual field device or of the further virtual field device, the time stamp of the access or of the request, and/or the type of the access or of the request. As a result, the attack can be analyzed and a possible extent can be traced.

According to an advantageous embodiment of the system according to the invention, it is provided that the first monitoring entity and/or the second monitoring entity are designed to detect further accesses or requests to further virtual field devices after the detection and to insert them into the first report or into the second report or into a further report. This allows the attackers behavior and, in some circumstances, also their strategy and/or their origin to be analyzed.

According to a first alternative of the system according to the invention, it is provided that the first monitoring entity and/or the second monitoring entity are designed to transmit the first report or the second report and/or the further report to the higher-level unit via a second communication channel.

According to an advantageous embodiment of the first alternative of the system according to the invention, it is provided that the higher-level unit is designed to evaluate the first report or the second report and/or the further report and to carry out at least one action based on the evaluation. In this way, it is possible to respond to the attack directly at the field level.

According to a further alternative of the system according to the invention, it is provided that the system comprises an evaluation unit, especially, a cloud-based evaluation unit, wherein the first monitoring entity and/or the second monitoring entity are designed to transmit the first report or the second report and/or the further report to the evaluation unit via a third communication channel.

According to an advantageous embodiment of the second alternative of the system according to the invention, it is provided that the evaluation unit is designed to evaluate the first report or the second report and/or the further report and to propose, based on the evaluation of the higher-level unit, at least one action to be carried out.

In all cases, it is essential that the reports are transmitted via communication channels different from the first communication channel. To the attacker who wrongly believes that they are safe, it is not apparent that their attack has already been detected and analyzed or that actions are being prepared. It may also be provided to thereby deliberately prolong the attack in order to obtain data of the attacker or the identity thereof and the location of the attack or the IP address thereof.

According to an advantageous embodiment of the system according to the invention, it is provided that the action is at least one of the following:
switch off at least one component of the communication network;
change or restrict access authorization to the edge device and/or to the service platform;
restrict the communication of the edge device;
inform the service personnel of the plant.

As a whole, an attack can be effectively determined and actions can be taken without the attacker being able to obtain actual data from the field devices of the first plant part.

The invention is explained in greater detail with reference to the following figures. Illustrated are:

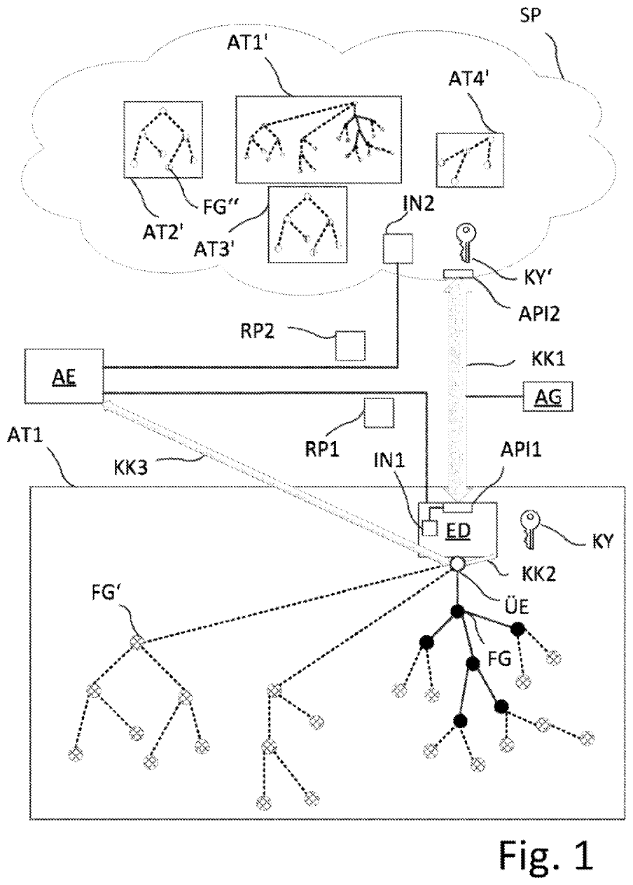

FIG. 1: an exemplary embodiment of the system according to the invention.

Schematically shown in FIG. 1 is a plant part AT1 of an automation plant. The plant may have further plant parts besides the first plant part AT1. In the first plant part AT1, a multitude of field devices FG are used which serve to sense or influence a physical variable of a process-engineering process. In FIG. 1, a black-filled circle represents the physical field devices actually used in the first plant part AT1.

The field devices FG are in communication with one another and with a higher-level unit ÜE, especially, a control unit (e.g., an SPC) or a gateway via a communication network. All higher-level units shown in FIG. 1 are represented by a white circle; the communication network is a wired communication network, e.g., a field bus of automation technology (e.g., based on the protocols HART, Profibus PA/DP, Foundation Fieldbus, etc.) or an Ethernet-based communication network. Alternatively, the communication network is a wireless communication network, e.g., an industrial wireless network, such as WirelessHART, or an IT wireless network, such as WiFi. It may also be provided that it is a mixed communication network, in which a first part of the network segments is wireless and in which a second part of the network segments is wired.

In order to monitor, record and further process data of the field devices FG even outside of the plant context, they are transmitted to a cloud-based service platform SP. One or more applications with which the monitoring and further processing of the data is made possible are executed on the cloud-based service platform SP. A user can connect by means of the Internet via a PC or a mobile terminal to the cloud-based service platform and, after successful authentication, can access the applications and the data of the field devices.

In order to transmit the data of the field devices FG, an edge device ED is provided, which is arranged at the field level in the first plant part AT1. The edge device is either connected to the higher-level unit ÜE or to a network segment of the communication network. The edge device ED is designed to extract data of the field devices from the data traffic of the communication network and to thus monitor the data, or to actively request the data from the field devices FG and/or the higher-level unit ÜE. For this purpose, the edge device ED has profiles or so-called microservices, which specify to the edge device ED which data of which field devices FG are to be monitored or queried at what frequency and, where applicable, how they are to be processed before the transmission to the cloud-based service platform SP.

The data of the field devices FG are transmitted via a first communication channel KK1 by means of the Internet. Specifically, the data are exchanged between a first interface API1 of the edge device ED and a second interface API2 of the cloud-based service platform SP. For this purpose, the data of the field devices FG are compiled in a so-called live list prior to the transmission. The live list contains all field devices FG currently active or defined in the edge device ED, and the current data thereof.

The data traffic via the first communication channel KK1 between edge device ED and cloud-based service platform SP is encrypted. For this purpose, the edge device ED1 has a private key KY for encryption. For decryption, the cloud-based service platform SP has a public key KY′ corresponding to the private key KY.

For an attacker AG, there are several potential points of attack in this system in order to obtain the data of the field devices FG:
The attacker could monitor the data traffic between edge device and vice versa and obtain knowledge of the public key KY or otherwise decrypt the encrypted data.
The attacker could gain access to the edge device ED via the first interface API1 and read the data directly from there.
The attacker could gain access to the edge device ED via the second interface API2 and read the data stored there.

The concept according to the invention for reducing the risk of an external attack is illustrated below. The concept is less about the aspect of making unauthorized access more difficult but rather about confusing the attacker, in the event that the attacker has gained unauthorized access, to the extent that they do not know what to do with the data obtained.

For this purpose, the edge device ED creates a multitude of further field devices FG′ (shown as shaded circles in FIG. 1), which are virtual and are not actually present in the first plant part AT1. For each of the virtual field devices FG, the edge device ED simulates data and transmits them in the live list to the cloud-based service platform SP. The identifiers of the field devices FG are in this case specifically encrypted with the private key KY or a further private key. However, the identifiers of the virtual field devices FG′ are not encrypted in this way. In this way, by decrypting the identifiers with the associated public key KY′, the cloud-based service platform SP can identify which field devices FG are actually contained in the plant and which field devices are virtual field devices FG′. Only the field devices FG actually present are displayed to the user of the application on the cloud-based service platform. However, to an attacker who has gained access to the data in one of the three above-described ways, it is not apparent that most of the data are simulated data.

So that the degree of confusion is as high as possible, the following two aspects are particularly important:
1.) The ratio of the virtual field devices FG′ to the actual, real field devices FG must be as high as possible. Frequently, an attacker requires more than just the data read by the edge device. They will therefore attempt to obtain access to the sensitive data of a field device FG, especially, the parameter settings thereof, via the identifier information in the live list via the edge device ED. The higher the ratio (e.g., starting at a factor of 10) is, the less likely it is for an attacker to read the data of a field device FG actually used in the plant.
2.) The data of the virtual field devices FG′ should not be distinguishable from the data of the real field devices FG at first glance. The data of the virtual field devices FG′ should therefore be as plausible as possible. For this purpose, the software of the edge device ED accesses historical data of field devices of a similar type of the virtual field devices FG or accesses an AI algorithm trained with training data of field devices. In addition, the type of a virtual field device must also be plausible and be suitable for the type of the plant.

In order to create further confusion and to thus increase security, the cloud-based service platform creates a multitude of further virtual plant parts AT2′, AT3′, AT4′. Each of these plant parts AT2′, AT3′, AT4′ in turn has a multitude of virtual field devices FG″ and virtual higher-level units for which data are again simulated. It is not apparent to the attacker which plant part AT1 is actually really present in the plant.

The system according to the invention furthermore also provides for detecting an attack of an unauthorized person. For this purpose, the edge device ED has a first monitoring entity IN1, and the cloud-based service platform SP has a second monitoring entity IN2. The first monitoring entity IN1 checks which field devices FG, FG′ are being accessed externally. The second monitoring entity IN2 checks which data of which field devices FG, FG′, FG″ are being accessed on the cloud-based service platform SP. If one of the two monitoring instances IN1, IN2 detects that access or an access request to a virtual field device FG′ or a further virtual field device FG′ is taking place, the respective monitoring entity IN1, IN2 detecting this process creates a first or a second report RP1, RP2; the first monitoring entity IN1 creates the first report RP1, the second monitoring unit IN2 accordingly creates the second report RP2. A report RP1, RP2 contains information about the identifier of the virtual field device FG′ or of the further virtual field device FG″ that has been accessed, as well as the date and time of access.

The corresponding report RP1, RP2 is transmitted from the edge device ED or the cloud-based service platform SP to the higher-level unit ÜE of the first plant part AT1 via a second communication channel KK2 different from the first communication channel KK1.

Alternatively, the corresponding report RP1, RP2 is transmitted from the edge device ED or the cloud-based service platform SP to an evaluation unit AE via a third communication channel KK3 different from the first communication channel KK1. This evaluation unit AE can be established especially as an application on the cloud-based service platform.

As a result of the communication channels KK2, KK3 different from the first communication channel KK1, the attacker AE does not find out that their unauthorized access has already been detected. The attacker AE can thus be analyzed further or a counter-attack can be started without the attacker AE noticing. For example, their position and/or their IP address can be detected.

The higher-level unit ÜE and/or the evaluation unit AE evaluates the corresponding report RP1, RP2 and ascertains an action in order to further protect the plant part AT1 or the field devices FG thereof. For example, depending on the type of access to the virtual field devices FG′, FG″, it may be provided to inform the plant personnel, to shut down corresponding plant parts and/or to change or restrict access authorization to the edge device ED and/or to the cloud-based service platform SP.

Through the system according to the invention, which implements a honeypot mechanism for the plant, an attacker can effectively be prevented from reading plant-relevant data, or appropriate actions can be proposed and carried out for further prevention.

### LIST OF REFERENCE SIGNS

API1, API2 First and second interface
AT1, AT1′, AT2′, AT3′, AT4′ Plant parts
ED Edge device
FG Field devices
FG′ Virtual field devices
FG″ Further virtual field devices
IN1 First monitoring entity
IN2 Second monitoring entity
KK1, KK2, KK3 Communication channels
KY Private key of edge device
KY′ Public key of cloud-based service platform
RP1, RP2 First and second report
SP Cloud-based service platform
ÜE Higher-level unit

1-14. (canceled)

15. Automation system comprising:
a first plant part consisting of a multitude of field devices and a higher-level unit, wherein the field devices are designed to sense measured values of at least one physical variable of a process-engineering process or to influence at least one physical variable of a process-engineering process,
wherein the field devices are in communication with one another and with the higher-level unit via a communication network, wherein the field devices are designed to transmit measured values, status values or diagnostic data to the higher-level unit, and wherein the higher-level unit is designed to transmit data to the field devices;
an edge device, which is part of the communication network, wherein the edge device is designed to monitor at least some of the data transmitted by the field devices and by the higher-level unit or to request further data from the field devices or from the higher-level unit, wherein the edge device is designed to generate a live list, which contains an identifier of each of the field devices or of the higher-level unit and the requested or monitored data, wherein the edge device is designed to simulate a multitude of virtual field devices, to generate data for the virtual field devices, to enter identifiers of the virtual field devices and the generated data into the live list, and to make the live list available via a first interface;
a cloud-based service platform, wherein the edge device is in communication with the cloud-based service platform using the Internet via a first communication channel,
wherein the edge device is designed to transmit the live list containing the requested or monitored data to the cloud-based service platform at regular intervals, and
wherein the cloud-based service platform is designed to prepare or present the live list, wherein the data of the virtual field devices are disregarded.

16. The system of claim 15, wherein the edge device is designed to encrypt the identifiers of the field devices and of the virtual field devices in the live list by means of a public key located on the edge device, wherein the cloud-based service platform is designed to decrypt the encrypted identifiers with a public key located on the cloud-based service platform, and wherein the identifiers of the virtual field devices cannot be decrypted.

17. The system of claim 15, wherein the cloud-based service platform is designed to simulate at least one second plant part with a multitude of further virtual field devices, to generate data for the further virtual field devices, to enter the identifiers of the further virtual field devices and the generated data into the live list, and to make the live list available via a second interface.

18. The system of claim 15, wherein the edge device or the cloud-based service platform comprises an algorithm, which is designed to analyze historical data of the field devices and to generate the data of the virtual field devices based on the analysis.

19. The system of claim 15, wherein the edge device or the cloud-based service platform comprises an algorithm and at least one model of a field device type, wherein the model has at least one specific attribute of the corresponding field device type, and wherein the algorithm is designed to generate the data of the virtual field devices by using the model.

20. The system of claim 15, wherein the edge device has a first monitoring entity, which is designed to detect external access or an external request via the first interface to at least one of the virtual field devices and to create a first report.

21. The system of claim 17, wherein the cloud-based service platform has a second monitoring entity, which is designed to detect external access or an external request via the second interface to at least one of the further virtual field devices and to create a second report.

22. The system of claim 20, wherein the first report contains information about the identifier of the virtual field device, the time stamp of the access or of the request, or the type of the access or of the request.

23. The system of claim 20, wherein the first monitoring entity is designed to detect further accesses or requests to further virtual field devices after the detection and to insert them into the first report or into a further report.

24. The system of claim 20, wherein the first monitoring entity is designed to transmit the first report or the further report to the higher-level unit via a second communication channel.

25. The system of claim 24, wherein the higher-level unit is designed to evaluate the first report or the further report and to carry out at least one action based on the evaluation.

26. The system of claim 20, further comprising an evaluation unit, wherein the first monitoring entity is designed to transmit the first report or the further report to the evaluation unit via a third communication channel.

27. The system of claim 26, wherein the evaluation unit is designed to evaluate the first report or the further report and to carry out at least one action based on the evaluation of the evaluation unit.

28. The system of claim 25, wherein the action is at least one of the following:
switch off at least one component of the communication network;
change or restrict access authorization to the edge device or to the cloud-based service platform;
restrict the communication of the edge device; and
inform the service personnel of the plant.
